(19) United States
(12) Patent Application Publication
(10) Pub. No.: US 2013/0271393 A1
(43) Pub. Date: Oct. 17, 2013

(54) ELECTRONIC DEVICE WITH TOUCH SCREEN AND UNLOCKING METHOD

(71) Applicant: PENG WANG, Shenzhen City (CN)

(72) Inventor: PENG WANG, Shenzhen City (CN)

(21) Appl. No.: 13/663,498

(22) Filed: Oct. 30, 2012

(30) Foreign Application Priority Data
Apr. 11, 2012 (CN) 201210104379.1

(51) Int. Cl. G06F 3/041

(52) U.S. Cl. 345/173

(57) ABSTRACT

An electronic device with a touch screen comprises a storage unit, a touch detecting module, a determining module and a control module. The storage unit is configured to store a predefined length and a predefined time period. The touch detecting module is configured to detect the screen unlock pattern applied on the touch screen and the trace length of the screen unlock pattern within the predefined time period. The determining module is configured to determine whether the detected length is equal to the predefined length value. The control module is configured to unlock the touch screen when the detected length is equal to the predefined length value. An unlocking method for the electronic device is also provided.

### BACKGROUND

1. Technical Field

The present disclosure relates to an electronic device with a touch screen and a unlocking method for the touch screen.

2. Description of Related Art

Touch screens are more and more popular recently. To avoid operating the touch screen unintentionally, the touch screen is locked when not in use, and a unlocking procedure such as entering a code or password is needed for unlocking the touch screen. However, the conventional unlocking methods have drawbacks. For example, the unlocking password is difficult to memorize, the unchangeable unlocking method is tedious and boring, which cannot satisfy the demands of various users.

Therefore, what is needed is an electronic device and a unlocking method thereof to alleviate the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device according to an exemplary embodiment.

FIG. 2 is a flowchart of an unlocking method for unlocking the touch screen of the electronic device of FIG. 1, in accordance with a first exemplary embodiment.

FIG. 3 is a flowchart of an unlocking method for unlocking the touch screen of the electronic device of FIG. 1, in accordance with a second exemplary embodiment.

### DETAILED DESCRIPTION

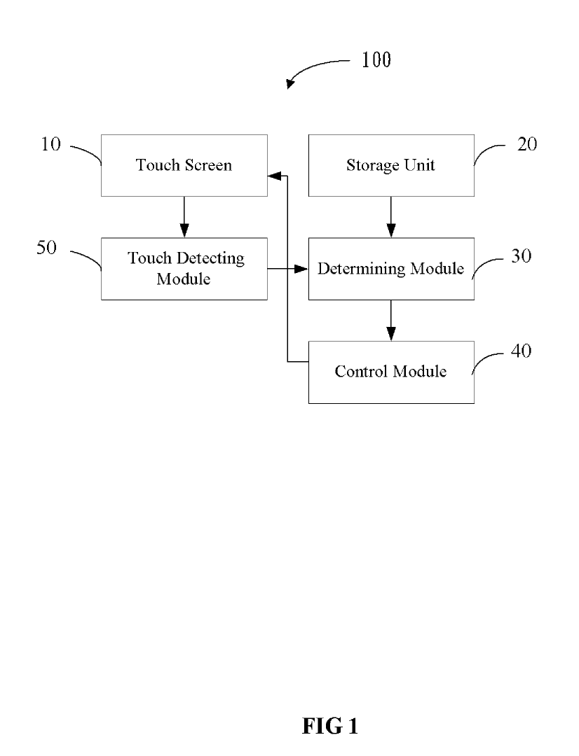

FIG. 1 is an electronic device 100 of an exemplary embodiment. The electronic device 100 includes a touch screen 10, a storage unit 20, a determining module 30, a control module 40, and a touch detecting module 50. When not in use, the touch screen 10 of the electronic device 100 is locked. When the touch screen 10 is locked, the touch detecting module 50 detects whether a screen unlock pattern is applied to the touch screen 10 within the predefined time period, if yes, the touch detecting module 50 detects the trace length of the detected screen unlock pattern. And the touch detecting module 50 transmits the trace length of the detected screen unlock pattern to the determining module 30. The detected screen unlock pattern may be continuous trace of a slide screen unlock pattern on the touch screen 10 or may include a plurality of discrete touch trace segments screen unlock pattern applied on the touch screen 10 within the predefined time period. And the trace length may be the length of the continuous trace of the slide screen unlock pattern or may be a total length of lengths of all the trace segments screen unlock pattern. The storage unit 20 stores a predefined length value and a predefined time period. The determining module 30 determines whether the trace length of the detected screen unlock pattern detected by the touch detecting module 50 is equal to the predefined length value. When the determining module 30 determines the detected trace length is equal to the predefined length value, the control module 40 unlocks the touch screen 10, otherwise the control module 40 keeps the touch screen 10 locked.

In an alternative embodiment, the touch detecting module 50 further detects the starting point of the screen unlock pattern and transmits the detected starting point to the determining module 30. The storage unit 20 further stores a predefined starting point of a screen unlock pattern. The determining module 30 also determines whether the detected starting point detected by the touch detecting module 50 is the same as the predefined starting point. When the detected length is equal to as the predefined length value and the detected starting point is the same as the predefined starting point, the control module 40 unlocks the touch screen 10, otherwise, the control module 40 keeps the touch screen 10 locked.

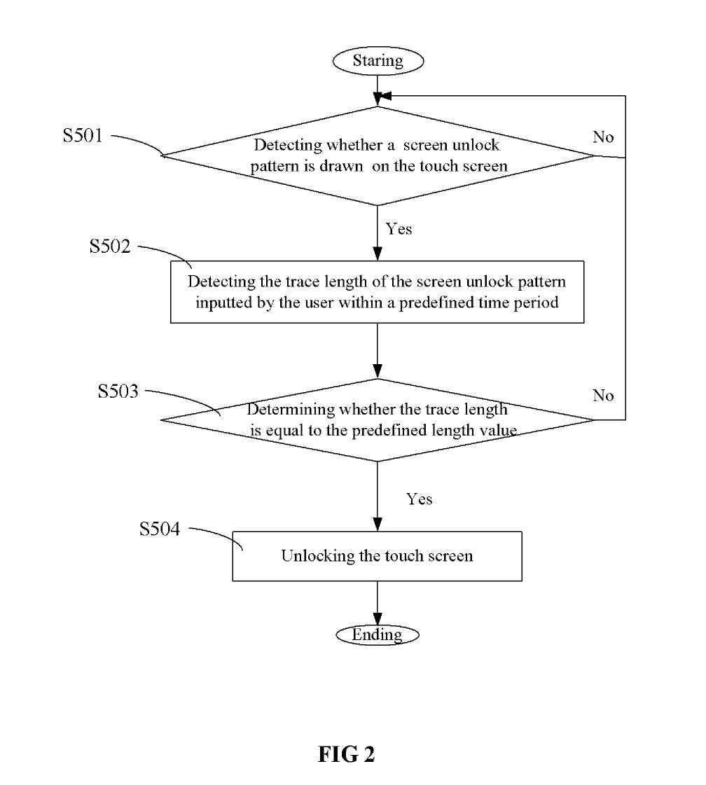

FIG. 2 is a flowchart of an unlocking method for unlocking the touch screen 10 of the electronic device 100 in accordance with a first exemplary embodiment The method includes the following steps, each of which is related to the various components contained in the electronic device 100.

In step S501: the touch detecting module 50 detects whether a screen unlock pattern is drawn by a user on the touch screen 10 when the touch screen 10 is locked. If yes, the process goes to step S502; if no, the process goes back to step S501.

In step S502: the touch detecting module 50 detects the trace length of the screen unlock pattern inputted by the user within a predefined time period. The screen unlock pattern may be a continuous trace of a slide screen unlock pattern on the touch screen 10 or may include a plurality of discrete touch trace segments screen unlock pattern applied on the touch screen 10 within the predefined time period. And the trace length may be the length of the continuous trace of the slide screen unlock pattern or may be a total length of lengths of all the trace segments screen unlock pattern.

In step S503: the determining module 30 determines whether the trace length detected by the touch detecting module 50 is equal to the predefined length value. If yes, the process goes to step S504; if no, the process goes back to step S501.

In step S504, the control module 40 unlocks the touch screen 10.

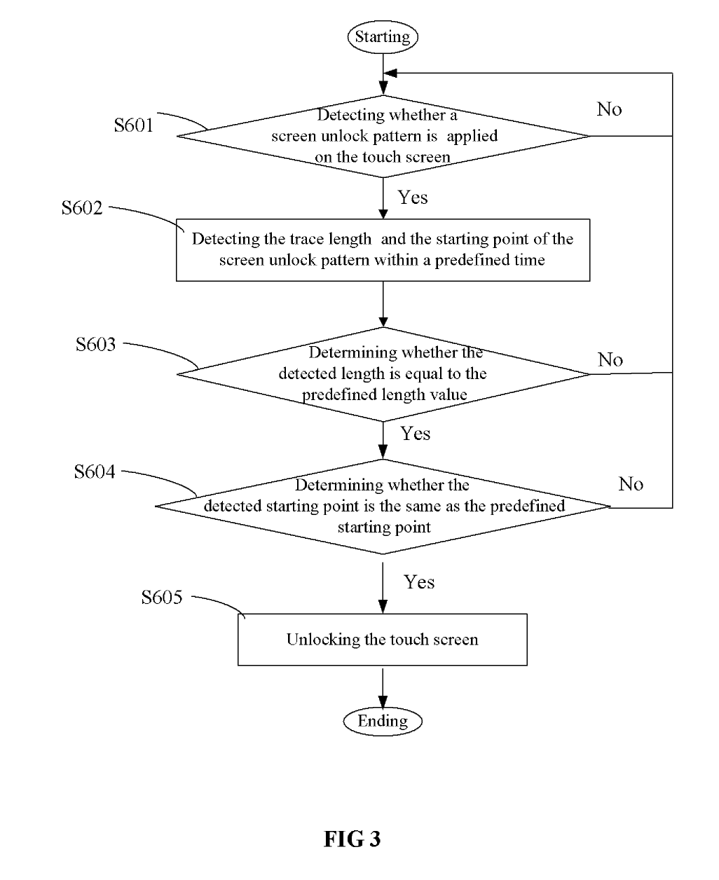

Referring to FIG. 3, a flow chart of a unlocking method for unlocking the touch screen 10 of the electronic device 100 in accordance with a second exemplary embodiment is shown. The method includes the following steps, each of which is related to the various components contained in the electronic device 100.

In step S601: the touch detecting module 50 detects whether a screen unlock pattern is applied on the touch screen 10 when the touch screen 10 is locked. If yes, the process goes to step S602; if no, the process returns back to step S601.

In step S602, the touch detecting module 50 detects the trace length and the starting point of the screen unlock pattern within a predefined time period. The detected screen unlock pattern may be a continuous trace of slide screen unlock pattern on the touch screen 10 or may include a plurality of discrete touch trace segments screen unlock pattern applied on the touch screen 10 within the predefined time period. And the trace length may be the length of continuous trace of the slide screen unlock pattern or may be a total length of lengths of all the trace segments screen unlock pattern.

In step S603: the determining module 30 determines whether the detected length detected by the touch detecting module 50 is equal the predefined length value. If yes, the process goes to step S604; if no, the process goes back to step S601.

In step S604: the determining module 30 determines whether the detected starting point detected by the touch detecting module 50 is the same as the predefined starting point. If yes, the process goes to step S605, if no, the process returns back to step S601.

In step S605: the control module 40 unlocks the touch screen 10.

The unlocking method of electronic device 100 provided by the present disclosure unlocks the touch screen 10 when the detected length detected by the touch detecting module 50 is equal to the predefined length value. Accordingly, once the trace length of several screen unlock patterns is equal to the predefined length value are confirmed, the touch screen 10 can be locked. So, users can use several screen unlock patterns in any combination to unlock the touch screen 10. And the unlocking process of the touch screen 10 can be much more fashionable and user-friendly.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device comprising:
a touch screen;
a storage unit configured for storing a predefined length and a predefined time period;
a touch detecting module configured to detect a screen unlock pattern applied by a user on the touch screen within the predefined time period;
a determining module configured to determine whether a trace length of the screen unlock pattern is equal to the predefined length value; and
a control module configured to unlock the touch screen if the trace length is equal to the predefined length value.

2. The electronic device as described in claim 1, wherein the detected screen unlock pattern is a continuous trace of a slide screen unlock pattern on the touch screen within the predefined time period.

3. The electronic device as described in claim 1, wherein the detected screen unlock pattern includes a plurality of discrete touch trace segments screen unlock pattern applied on the touch screen within the predefined time period.

4. The electronic device as described in claim 3, wherein the trace length is a total length of lengths of all the trace segments screen unlock pattern.

5. A touch screen unlocking method comprising:
detecting a screen unlock pattern drawn by a user on a touch screen when the touch screen is locked;
detecting a trace length of the screen unlock pattern inputted by the user within a predefined time period;
determining whether the trace length is equal to a predefined length value; and
unlocking the touch screen if the trace length is equal to the predefined length value.

6. The touch screen unlocking method as described in claim 5, wherein the detected screen unlock pattern is a continuous trace of a slide screen unlock pattern on the touch screen within the predefined time period.

7. The touch screen unlocking method as described in claim 5, wherein the detected screen unlock pattern includes a plurality of discrete touch trace segments screen unlock pattern applied on the touch screen within the predefined time period.

8. The touch screen unlocking method as described in claim 7, wherein the trace length is a total length of lengths of all the trace segments screen unlock pattern.

9. An electronic device comprising:
a touch screen;
a storage unit configured for storing a predefined length value, a predefined starting point of a screen unlock pattern and a predefined time period;
a touch detecting module configured to detect a screen unlock pattern drawn by a user on the touch screen within the predefined time period; and detect the trace length and the starting point of the screen unlock pattern;
a determining module configured to determine whether a trace length of the detected screen unlock pattern is equal to the predefined length value and whether a starting point of the screen unlock pattern drawn by the user is the same as the predefined starting point; and
a control module configured to unlock the touch screen if the trace length is equal to the predefined length value and the starting point of the screen unlock pattern drawn by the user is the same as the predefined starting point.

10. The electronic device as described in claim 9, wherein the detected screen unlock pattern is a continuous trace of a slide screen unlock pattern on the touch screen within the predefined time period.

11. The electronic device as described in claim 9, wherein the detected screen unlock pattern includes a plurality of discrete touch trace segments screen unlock pattern applied on the touch screen within the predefined time period.

12. The electronic device as described in claim 11, wherein the trace length is a total length of lengths of all the trace segments screen unlock pattern.
